(19) United States
(12) Patent Application Publication
(10) Pub. No.: US 2001/0017039 A1
(43) Pub. Date: Aug. 30, 2001

(54) Electric system

(75) Inventor: Jurgen Weimer, Euerbach (DE)

Correspondence Address: Thomas C. Pontani, Esq., Cohen, Pontani, Lieberman & Pavane, Suite 1210, 551 Fifth Avenue, New York, NY, 10176, US

(73) Assignee: Mannesmann Sachs AG

(21) Appl. No.: 09/783,432

(22) Filed: Feb. 14, 2001

(30) Foreign Application Priority Data
Feb. 29, 2000 (DE) 100 09 521.6

(51) Int. Cl. B60H 1/32; F25D 23/12

(52) U.S. Cl. 62/259.2; 62/244

(57) ABSTRACT

The description relates to an electric system with at least one electric component such as an electric machine and at least one control device for controlling the electric component. The electric system further comprises a cooling device for cooling at least one component part of the at least one electric component or the at least one control device. To achieve an effective and stable cooling of the component part, the cooling device has an air conditioning system with a coolant circuit including an air conditioning compressor, a condenser, an evaporator, and line elements connecting these. The at least one component part to be cooled is arranged in the coolant circuit.

### BACKGROUND OF THE INVENTION

1. Field of the Invention

The present invention relates to an electric system having a component, a controlling device for controlling the component, and a cooling device for cooling one of the controlling device and the component. The present invention further relates to a motor vehicle having an air conditioning system for cooling the electric system.

2. Description of the Related Art

Electric systems usually have at least one electric component which is controlled by at least one control device. Electric systems of this kind are very common in practice.

Electrical systems are used, for example, in the automotive industry in a wide variety of functions. For instance, the electric component may be an electric drive. The use of electric components in the drive arrangement of motor vehicles such as, for example, in the drivetrain is also very common.

The electric drive may, for example, be an electric machine such as a synchronous machine for generating electrical energy. The generated electrical energy is then supplied to a great variety of consumers. A specific example of such an electric machine is the crankshaft starter generator which is integrated in the drivetrain of passenger motor vehicles in combination with a corresponding clutch or transmission. A crankshaft starter generator is, for example, a magneto-electric synchronous machine which is arranged in the drivetrain between the crankshaft of the internal combustion engine and a clutch or transmission. The crankshaft start generator is used to start the internal combustion engine. Further, this crankshaft starter generator works as a generator during driving operation. Accordingly, the starter generator works as both a starter and a generator in the motor vehicle.

The electric components such as the crankshaft starter generator described above are generally controlled by a control device. A control device for a starter generator has various component parts. These component parts include power electronics devices.

An example of power electronics devices of this kind is described in a prior U.S. patent application Ser. No. 09/553,580, filed Mar. 23, 2000 by the present Applicant. These power electronics devices comprise a power part having a plurality of capacitors and a plurality of power semiconductors. The power electronics devices are connected with a power bus. Further, the power electronics devices have a control component for the power part. For example, a powerful microcontroller is arranged in the control component for control purposes. Further, a device is also provided for supplying power. The power electronics devices control the electric component connected with them such as, for example, the starter generator.

Heat loss normally occurs during the operation of an electric component or control device and must dissipated.

A separate cooling device may be provided for performing the required cooling. However, this solution is very energy-intensive because the individual elements of the cooling device such as, for example, pumps must be driven. Further, a solution of this kind requires a relatively large amount of space for the additional components which is very disadvantageous particularly in the automobile industry because of the limited space available in the engine compartment.

When power electronics such as, for example, those described above for an electric machine in a vehicle are to be cooled, the electric machine may have a cooling component connected with the individual component parts of the power electronics such that a thermal exchange takes place between these component parts and the cooling device. When the power electronics are used in a vehicle, the source for a coolant flowing through the cooling component is usually the conventional cooling circuit of the internal combustion engine. The connection element of the cooling component is connected with the cooling circuit of the internal combustion engine, so that the cooling water circulating in the internal combustion engine also flows through the cooling component of the power electronics. This solution does not require additional cooling means such as pumps for the cooling component.

However, the coolant of the internal combustion engine already has a relatively high temperature when entering the power electronics.

Therefore, a further improvement in the cooling power and cooling action of the cooling device for an electric component and/or a control device for the electric component is required.

### SUMMARY OF THE INVENTION

It is the object of the present invention to provide an electric system with a particularly effective and stable cooling of an electric component and/or a control device of the electric system. Further, the electric system of the present invention should be constructed in a simple, inexpensive and space-saving manner. Also, a correspondingly improved motor vehicle is to be provided including the electric system.

The object according to the present invention is met by an electric system with at least one electric component, at least one control device for controlling the at least one electric component, and with a cooling device for cooling a component of one of the at least one electric component and the at least one control device. According to the present invention, the cooling device has a climate-control or air conditioning system. The air conditioning system has a coolant circuit with an air conditioning compressor, a condenser, an evaporator and line elements connecting these elements, and in that the at least one component part to be cooled of the at least one electric component or of the at least one control device is arranged in the coolant circuit.

The construction of the electric system according to the present invention, the component part to be cooled is cooled in a particularly effective and stable manner.

Electric components as well as control devices for controlling such electric components may be cooled by the cooling device. The present invention is not limited to certain examples or embodiment forms of such electric components or control devices.

The electric system of the present invention is shown with only one electric component of this type. However, it is also possible that the electric system contains a plurality of electric components. The term electric component includes any type of component part which either consumes electrical energy or generates electric energy. Further, at least one control device is provided for controlling the electric component. It is possible that an independent control device is assigned to each electric component. Of course, one control device may also assume control of a plurality of electric components.

At least individual component parts of the at least one electric component and/or of the at least one control device generate heat losses during operation which must be dissipated in a suitable manner. The lost heat is carried off by a cooling device.

According to the invention, the cooling device is an air conditioning system. The air conditioning system allows a particularly effective and stable cooling. Air conditioning systems are known per se. The construction of an air conditioning system, particularly an air conditioning system for an automobile, is described, for example, in Bosch Automotive Handbook, 4th Edition, pages 737-738. The disclosed content of this passage with respect to air conditioning systems is incorporated by reference in the specification of the present invention.

An air conditioning system usually has a coolant circuit which, in turn, comprises a number of individual components including, for example, the compressor, condenser, evaporator and various line segments connecting these elements.

The compressor causes the coolant flowing through the coolant circuit to circulate. For this purpose, the compressor draws in cold, gaseous coolant from the evaporator, compresses it and then pushes the coolant to the condenser.

The coolant which is still in gaseous form, but is heated by the compression, is cooled in the condenser and passes (condenses) from the gaseous state to the liquid state.

The coolant which is now liquefied is then supplied to the evaporator. The liquid coolant normally enters the evaporator under increased pressure and passes into the gaseous state in the latter at low pressure. During this process, the coolant takes the required heat energy which it needs for evaporation from its surroundings.

The individual components of the coolant circuit are connected with one another via line segments through which liquid or gaseous coolant flows.

The at least one component part to be cooled of the at least one electric component and/or of the at least one control device is arranged in the above-described coolant circuit. Accordingly, the high cooling output of the air conditioning system is also used for cooling the component part.

When the electric system is provided in a motor vehicle, for example, a particularly compact construction is realized because no additional component elements are required for cooling the electric system. The air conditioning system is usually arranged in the vehicle anyway. The following description contains examples of where and how the component parts to be cooled can be arranged in the coolant circuit.

The use of the coolant circuit of an air conditioning system for cooling the component part has a number of advantages. Temperature fluctuations which may occur when an electric component and/or a control device is to be cooled in a motor vehicle by the coolant circuit of the internal combustion engine are eliminated. The temperature of the coolant in a known cooling system of this type depends on the different operating states of the vehicle and therefore can not vary substantially. However, an air conditioning system generates a substantially constant and low temperature at all times independent of the different operating states of the motor vehicle.

The life of the individual elements of the component parts to be cooled are improved because they are no longer exposed to alternating thermal load or large temperature cycles. Therefore, the cooling according to the present invention may be used in control devices because these control devices generally have a number of highly sensitive component elements such as power semiconductors.

Apart from increased life, the improved cooling also achieves better efficiency. Accordingly, individual component elements of smaller dimensions such as, for example, the power semiconductors of a control device, may be provided because of the improved cooling action. The favorable cooling also allows the individual elements of the component part to be arranged at a closer distance to one another, which leads to a reduced space requirement for the entire electric component or control device. This has considerable importance particularly in the automotive sector.

By reducing the temperature of the coolant, the heat losses occurring in the electric component or control device, for example, in its power electronics may be drastically reduced.

The coolant flowing through the coolant circuit of the air conditioner may be a liquid in its initial state. The at least one component part to be cooled of the at least one electric component and/or of the at least one control device may have a quantity of cooling ducts and be arranged in the coolant circuit such that the coolant flows through the cooling ducts.

In this case, the coolant circulates in the closed coolant circuit in the line system and in the components arranged therein and constantly changes between the liquid and gaseous state. The known coolant R 134 A may be used as coolant.

The component part to be cooled is arranged in the coolant circuit such that coolant flows through it. For this purpose, corresponding cooling ducts may, for example, be provided in the component part. The component part to be cooled may be integrated in the line system of the coolant circuit by arranging it between two line segments. The individual cooling ducts are connected with the line segments via a corresponding coupling device, so that the coolant flowing through the line segments also flows through the component part to be cooled.

In another embodiment, the coolant flowing through the coolant circuit is a gas in its initial state and the at least one component part to be cooled is arranged in the coolant circuit in such a way that coolant flows around it, or around at least individual elements of the component part.

Efforts have been made recently in this regard to replace the previously conventional coolant with a gas such as, for example, carbon dioxide. In this case, the component part to be cooled, or individual elements thereof, is arranged within the gas flow, so that gas preferably flows around these component elements on all sides. This ensures a particularly effective cooling.

As was described above, the present invention is not limited to any specific types of electric components or control devices. For a clearer illustration, the present invention will be described in the following using a specific—but non-exclusive—example from the automotive field.

In a specific example, the electric component is an electric machine having a rotor and a stator. The stator and/or the rotor are cooled by the cooling device. For example, a machine of this kind comprise a crankshaft starter generator of the type described in the beginning. The heat losses occurring in the stator and rotor are usually guided off by means of a cooling system having a number of cooling ducts which penetrate the stator and rotor. Coolant flows through the individual cooling ducts, wherein the occurring heat losses are absorbed and guided off by the coolant.

When an electric machine of this type was used in a motor vehicle, cooling of the stator and rotor was formerly carried out by the cooling circuit of the internal combustion engine. The cooling effect can now be improved and the advantages described above can be achieved by cooling according to the present invention, as was described above, by the air conditioning system and coolant circuit.

A control device may also be cooled in the manner according to system of the present invention. The control device has power electronics, wherein the power electronics are cooled via the cooling device. The construction of power electronics of this kind is described, for example, in the above-cited U.S. patent application Ser. No. 09/533,580, the entire contents of which are incorporated by reference in the specification of the present invention.

The power electronics preferably have a cooling component with at least one cooling duct for the coolant, wherein the at least one cooling duct is arranged in the coolant circuit such that the coolant flows through it. Due to the particularly good cooling effect that is achieved through the use of the coolant circuit of the air conditioning system, the individual elements of the power electronics may have smaller dimensions and be assembled more compactly. Accordingly, the space requirement for the power electronics may be significantly reduced over the prior art, which is an enormous advantage especially in the automotive sector.

The component part to be cooled may be arranged in the coolant circuit at different locations in the coolant circuit. In this respect, the invention is not limited to specific variants of the arrangement. Some exemplary embodiments for positioning the component part to the cooled are described in the following.

The at least one component part to be cooled of the at least one electric component and/or of the at least one control device may be arranged before the evaporator in the coolant circuit. In this embodiment, the at least one component part to be cooled is located between the condenser and the evaporator so that liquid coolant flows through this component part when using a coolant which is liquid in the initial state.

It is also possible that the at least one component part to be cooled of the at least one electric component and/or of the at least one control device may be arranged in the coolant circuit after the evaporator. Therefore, gaseous coolant flows through the at least one component part to be cooled when using coolant that is liquid in the initial state.

In another embodiment, the at least one component part to be cooled of the at least one electric component and/or of the at least one control device may be arranged in a bypass line bypassing the evaporator. This embodiment, when used with appropriate valves, allows the component part to be cooled to be selectively connected to the coolant circuit or disconnected, as required.

Naturally, other embodiments of the arrangement are also possible and combinations of individual variants of the arrangements are conceivable.

The present invention also relates to a motor vehicle with an air conditioning system and which includes an electric system according to the present invention as described above.

Most modern motor vehicles have an air conditioning system. Therefore, no additional components are required for cooling the individual component parts of the electrical system. This reduces the space requirement for the cooling device. Further, a stable and optimal cooling of the component parts of the electric system which are to be cooled is made possible by the cooling power supplied by the air conditioner.

With respect to the advantages, actions, effects and manner of functioning of the electric system in the motor vehicle, reference is had to the preceding statements regarding the electric system according to the invention in their entirety.

An electric component of the electric system may be constructed as an electric machine such as a starter generator, wherein a control device which is provided in addition is preferably constructed for controlling this electric machine.

Therefore, according to the present invention, a motor vehicle is provided with a simply designed, inexpensive, space-saving and nevertheless effective cooling device for electric components of a starter generator system which is particularly suitable for cooling the power electronics of the starter generator system.

The invention is not limited to specific components inside the motor vehicle and it may be used in connection with every electric component and/or every control device for such component found in the drivetrain or in its periphery, for example, in the vehicle power supply.

According to a third aspect of the present invention, the coolant circuit of an air conditioning system is used for cooling at least one component part of an electric component which may, for example, include an electric machine and/or at least one component part of a control device for controlling the electric machine having power electronics.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a perspective partial cutaway view of a component part of a control device of an electrical system, which component part includes power electronics and is to be cooled;

FIG. 1a is a schematic diagram showing the component part in a motor vehicle according to an embodiment of the present invention;

FIG. 1b is a schematic diagram of an electric machine showing connection for a coolant;

FIG. 2 is a schematic circuit diagram for cooling a component part of an electric system according to an embodiment of the present invention;

FIG. 3 is a schematic circuit diagram for cooling a component part of an electric system according to another embodiment of the present invention; and

FIG. 4 is a schematic circuit diagram for cooling a component part of an electric system according to yet another embodiment of the present invention.

### DETAILED DESCRIPTION OF THE PRESENTLY PREFERRED EMBODIMENTS

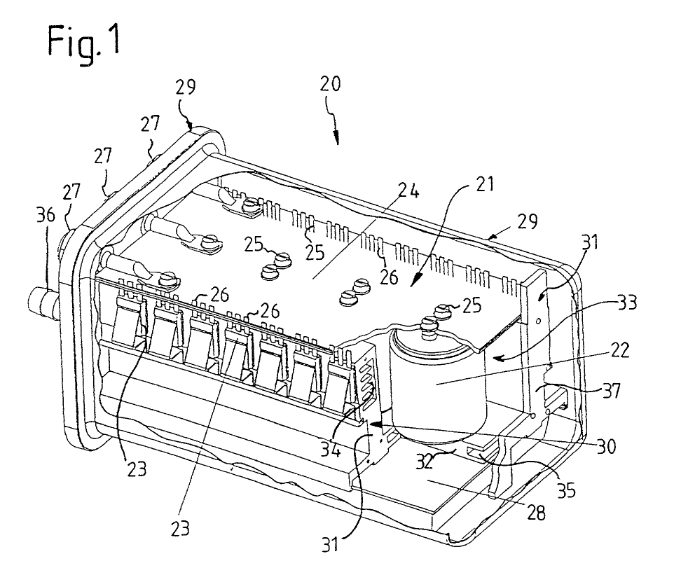

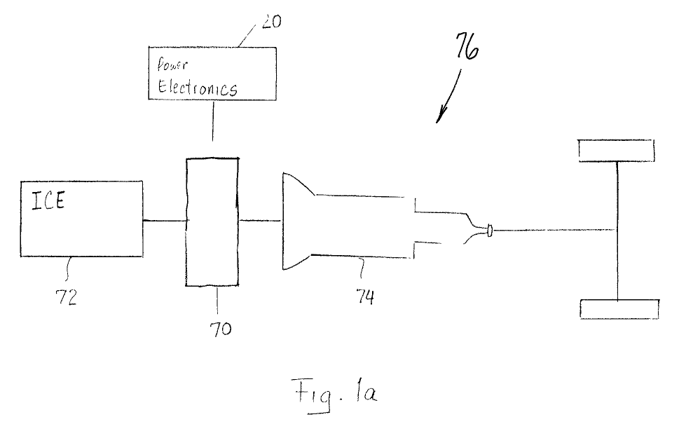

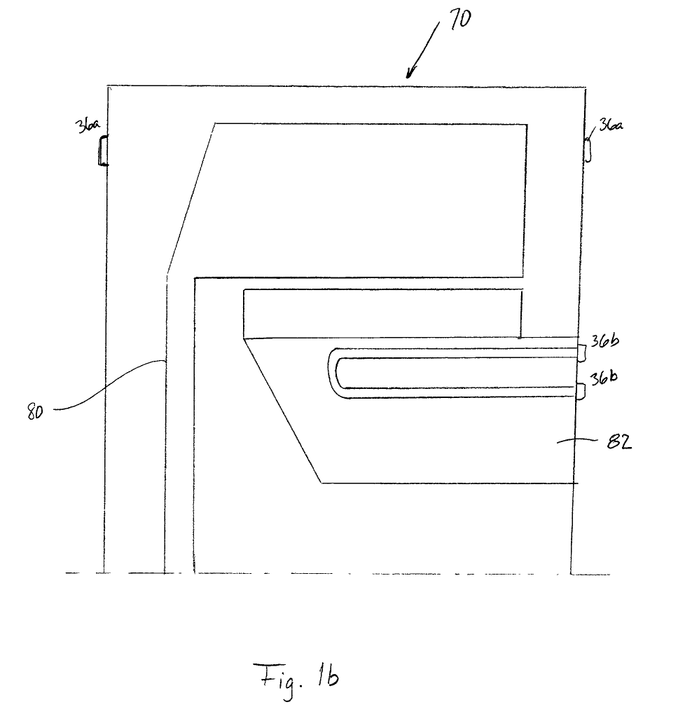

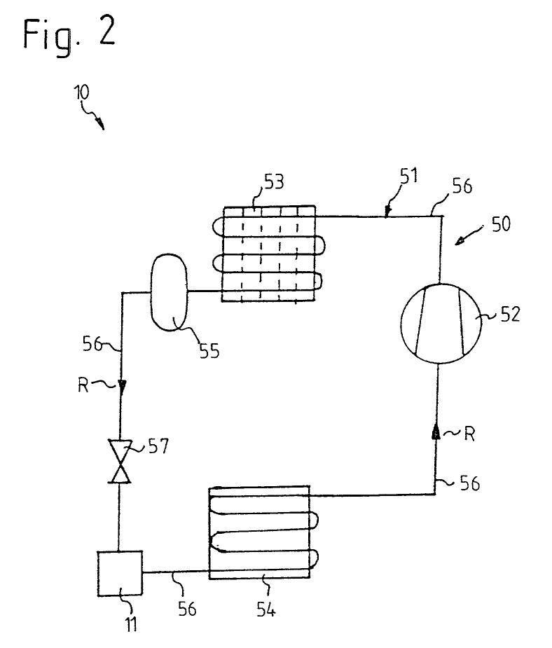

FIGS. 1 and 1a show power electronics 20 for controlling an electric machine 70, wherein the electric machine 70 is a starter generator constructed as a permanently excited synchronous machine arranged in the drive train of a vehicle 76. FIG. 1a shows that the electric machine 70 may be connected between an Internal Combustion Engine (ICE) 72 and a transmission 74. Accordingly, the electric machine 70 may be used as a starter for the ICE 72 and may be used as a generator for generating electricity when the ICE 72 is running. The power electronics 20 comprise a component part 11 (see FIGS. 2 to 4) of a control device which is to be cooled according to an embodiment of the present invention. However, the component part 11 may alternatively comprise the electric machine 70. The connection of the component part 11 to a cooling circuit will be explained more fully with reference to FIGS. 2 to 4.

The power electronics 20 have a housing 29 produced as an aluminum deep-drawn part. The housing 29 is closed on all sides with the exception of a housing opening at the front end. The housing opening is closed by a cover element, wherein the cover element is detachably connected with the housing 29. The cover element has a plurality of openings through which a corresponding plurality of connection elements 27, 36 are guided. The cover element accordingly functions as a connection board of the power electronics 20.

With regard to the connection elements, some of the plural connection elements 27 are connected with a power part 21 of the power electronics 20. Others of the plural connection elements 36 are guided through the cover element so that a cooling component 30 in the power electronics can be connected with a cooling device via these connection elements 36.

As will be seen from FIG. 1, the power electronics 20 have a power section 21. The power section 21 has a plurality of capacitors 22. Each of the capacitors 22 is connected with a power bus 24 via a screw connection 25. The power bus 24 is preferably made of copper.

The power section 21 also includes a plurality of power semiconductors 23 which are likewise connected with the power bus 24 via plug-in connections 26. For this purpose, the power semiconductors 23 have a quantity of plates which are inserted through the power bus 24 and connected therewith, for example, by a solder connection or the like. The power semiconductors 23 may, for example, comprise MOSFETs. Both the capacitors 22 and the power semiconductors 23 are connected by the power bus 24.

A central control component 28 is constructed as a printed circuit board and assumes all controlling, monitoring and regulating functions, including control of the power semiconductors 23. The central control component is provided for operation of the power electronics 20. The control device 28 is arranged below a base area 32 of the cooling component 30. Accordingly, the control component 28 may also be cooled by cooling which acts downward over the base region 32.

The capacitors 22 are arranged in a row in the center of the housing 29 and are flanked by two rows of power semiconductors 23 such that the power semiconductors 23 are located between the side wall of the housing 29 and the capacitors 22.

A cooling component 30 is provided for removing the heat losses generated in the component part 11 by the power semiconductors 23 and capacitors 22 during the operation of the power electronics 20. The cooling component 30 may be constructed as an aluminum deep-drawn section or extruded aluminum part and has a substantially U-shaped cross section. The cooling component 30 has two side legs 31 and a base region 32. The capacitors 22 are arranged in a space 33 formed by the side legs 31 and the base region 32, so that cooling of the capacitors may be effected in a lateral direction and a downward direction in the space 33. The power semiconductors 23 are arranged on the outside of the side legs 31 of the cooling components 30, which ensures a lateral cooling of the power semiconductors 23 via the side legs 31. A cooling duct 34 is arranged through the side legs 31. This cooling duct 34 may include a quantity of cooling ribs so that the surface available inside the cooling duct 34 for cooling is increased resulting in increased cooling capacity.

Furthermore, cooling ducts 35 are also provided in the base region 32 of the cooling component 30.

A suitable coolant flows through the cooling ducts 34, 35. As will be explained more fully below with reference to FIGS. 2-4, the coolant may be the coolant circulating in a coolant circuit of an air conditioning system. For this purpose, the cooling ducts 34, 35 are connected with the coolant circuit via the connection elements 36.

The cooling ducts 34, 35 are closed at their open end opposite the cover element by a cap element 37. The individual cooling ducts 34, 35 are connected either in series or in parallel by the cap element 37. The cap element 37 may be changed to adjust the pressure ratios and the through-flow ratios in the cooling component 30.

To achieve efficient cooling action, the cooling component 30 is arranged with the capacitors 22 and the power semiconductors 23 such that a heat exchange can occur directly between the power electronics 20 and the cooling component 30.

FIG. 1b shows the electric machine 70 having a stator 82 and a rotor 80. The electric machine 70 may also be the component part 11. The stator 82 has connection elements 36a and a coolant duct 84 for receiving liquid coolant. Connection elements 36b are connectable to a coolant circuit so that the gaseous coolant flows over the rotor 80 and thereby removes heat therefrom. Either one or both of these connection elements 36a, 36b may be arranged on the electric machine 70.

Cooling is achieved as described in connection with FIGS. 2, 3 and 4. FIG. 2 shows a first embodiment example of an electric system 10 in which a component part 11 of an electric component and/or of a control device is to be cooled in a suitable manner. The component part 11 may comprise the power electronics 20 shown and described with reference to FIG. 1 or the electric machine 70 shown in described with reference to FIG. 1b. Furthermore, the component part 11 may comprise any electric or electronic component which requires removal of generated heat loss.

Cooling of the component part 11 is effected via a cooling device comprising an air conditioning system 50. The air conditioning system 50 has a closed coolant circuit 51 through which a cooling medium circulates which is liquid in its initial state. An air conditioning compressor 52 is arranged in the coolant circuit 51 for drawing in gaseous coolant from an evaporator 54, compressing the coolant and pushing the coolant to a condenser 53. The coolant gas is heated when compressed and is quickly cooled in the condenser 53 so that it passes from the gaseous to the liquid state, i.e., is condensed. Following the condenser 53 in the coolant circuit 51 is a collector/dryer 55 serving as equilibrium vessel and reservoir. The coolant, now in the liquid state, is transported from the collector/dryer 55 in flow direction R toward the evaporator 54. An expansion valve 57 is arranged before the entrance to the evaporator 54 in which the coolant under high pressure is expanded.

Further, the component part 11 (i.e., the power electronics 20 or the electric machine 70) of the control device which is to be cooled is inserted in the coolant circuit 51 in front of the evaporator 54. The individual components of the coolant circuit 51 are connected with one another via line segments 56.

The power electronics 20 are connected with the line segments 56 via the connection elements 36 such that the coolant flowing through the line segments 56 also flows through the cooling ducts 34, 35 of the cooling component 30. This configuration ensures an effective and stable cooling of the individual elements in the power electronics 20, thereby allowing the power electronics 20 to be made smaller and arranged closer together than the prior art arrangement.

After exiting from the power electronics 20, the coolant which is still in liquid state enters the evaporator 54 where it is changed from its liquid state under high pressure to its gaseous state under lower pressure. During this process, the coolant draws off from its surroundings the heat energy required for evaporation. The coolant, which is now in gaseous form again and enters the air conditioning compressor 52 to repeat the cycle.

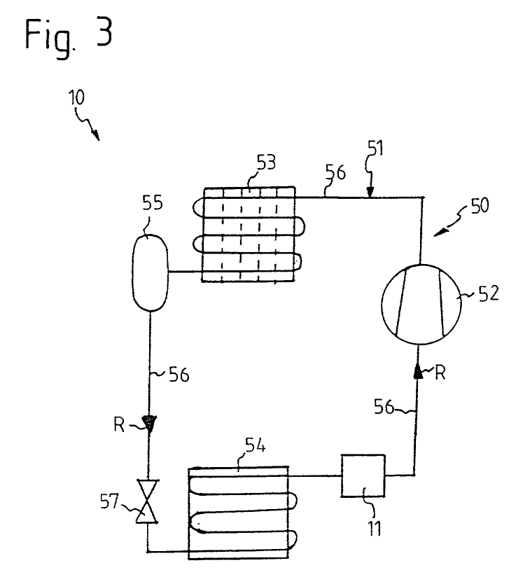

FIG. 3 is another embodiment of an electric system 10. In this embodiment, parts which correspond to the parts already described with reference to FIG. 2 are provided with the same reference numbers. Therefore, a new description of the basic construction may be dispensed with to avoid repetition.

The difference between the embodiment in FIG. 3 and the embodiment in FIG. 2 is that the component part 11 to be cooled is arranged behind rather than in front of the evaporator 54 in the coolant circuit 51. Accordingly, in this embodiment form the coolant flows through the component part 11 in the gaseous state. Therefore, in this embodiment, the component part 11 may comprise the electric machine 70 which is connected in the coolant circuit 51 via the connection elements 36a so that the gaseous coolant flows around the rotor 80. Of course, the power electronics 20 may also be arranged so that a gaseous coolant flows around the power semiconductors and capacitors.

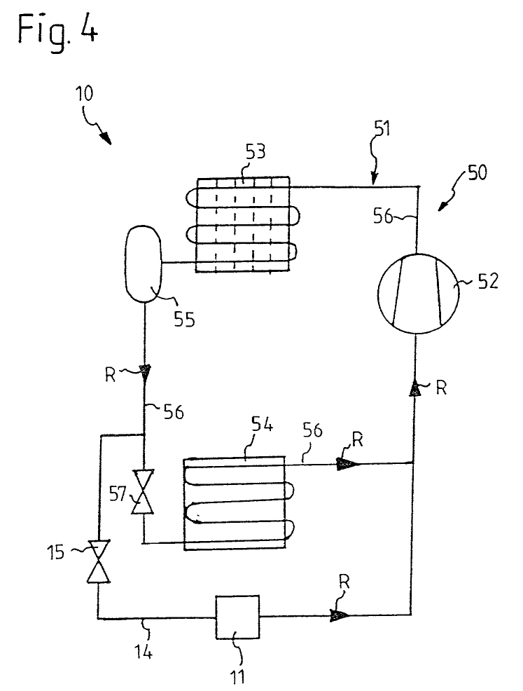

FIG. 4 shows another embodiment form of an electric system 10 according to the invention. The basic construction of the electric system 10 in FIG. 4 corresponds to the basic construction described with reference to FIGS. 2 and 3 and identical parts are again provided with the same reference numbers. Reference is had to the remarks relating to FIGS. 2 and 3 for the basic construction and manner of functioning of the electric system 10 according to FIG. 4.

In the embodiment of FIG. 4, the component part 11 to be cooled is not arranged directly in the coolant circuit 51. Instead, the component part 11 is located in a bypass line 14 which bypasses the evaporator 54. Accordingly, the component part 11 may be selectively connected to the coolant circuit 51 for cooling purposes or disconnected therefrom. To bring the coolant to a suitable pressure, a suitable expansion valve 15 is provided in the bypass line 14 in front of the component part 11 in flow direction R of the coolant. The expansion valve 15 performs the same function as the expansion valve 57.

The expansion valve 15 be an independent structural member or may be integrated within the component part 11 such as, for example connected with the connection 36. To adjust the flow quantity of the coolant which flows through the bypass line 14 and therefore through the component part 11, additional valves may be provided in the bypass line 14. However, the adjustment of the flow rate and flow quantity may be regulated via the expansion valve 15.

The electric system 10 according to the invention enables a particularly effective and stable cooling of the component part 11, wherein the cooling device can be realized in a simple, inexpensive and space-saving manner because no additional components or structural elements are required.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An electric system, comprising:
an electric component;
a control device for controlling said electric component; and
a cooling device for cooling a component part of one of said electric component and said control device, said cooling device comprising an air conditioning system including a coolant circuit having a coolant flowing therethrough with a compressor, a condenser, an evaporator, and line elements connecting said compressor, said condenser, and said evaporator, wherein said component part is connected in said coolant circuit.

2. The electric system of claim 1, wherein said coolant flowing through the coolant circuit is a liquid in its initial state, and wherein said component part to be cooled includes a plurality of cooling ducts, said component part being arranged in said coolant circuit such that coolant flows through said cooling ducts.

3. The electric system of claim 1, wherein said coolant flowing through said coolant circuit is a gas in its initial state, and said component part to be cooled is arranged in said coolant circuit such that said coolant flows around one of said component part and individual elements of said component part.

4. The electric system of claim 1, wherein said electric component comprises an electric machine having a rotor and a stator, and wherein at least one of said stator and said rotor is cooled by said cooling device.

5. The electric system of claim 1, wherein said control device comprises power electronics, and wherein said power electronics are cooled by said cooling device.

6. The electric system of claim 5, wherein said power electronics comprise a cooling component having at least one cooling duct for receiving said coolant, and wherein said at least one cooling duct is arranged in said coolant circuit such that said coolant flows through it.

7. The electric system of claim 1, wherein said component part to be cooled is arranged before said evaporator in said coolant circuit.

8. The electric system of claim 1, wherein said component part to be cooled is arranged after said evaporator in said coolant circuit.

9. The electric system of claim 1, wherein said cooling device comprises a bypass line bypassing said evaporator, and wherein said component part to be cooled is arranged in said bypass line.

10. A motor vehicle, comprising:
an electrical system comprising an electric component and a control device for controlling said electric component; and
a cooling device for cooling a component part of one of said electric component and said control device, said cooling device comprising an air conditioning system including a coolant circuit having a coolant flowing therethrough with a compressor, a condenser, an evaporator, and line elements connecting said compressor, said condenser, and said evaporator, wherein said component part is arranged in said coolant circuit.

11. The motor vehicle of claim 10, wherein said electric component is a starter generator of said vehicle and said control device is constructed for controlling said starter generator.

12. A procedure for cooling a component part of one of an electric component and a control device for controlling the electric component comprising the step of using a coolant circuit of an air conditioning system for cooling the component part.
